(19) United States
(12) Patent Application Publication
(10) Pub. No.: US 2008/0009293 A1
(43) Pub. Date: Jan. 10, 2008

(54) Location information of a called mobile terminal provided to a calling terminal

(76) Inventors: Andrew Jonathan Bennett, Swindon (GB); Man Hung Ng, Swindon (GB)

Correspondence Address: Lucent Technologies Inc.;Docket Administrator, Room 3J-219, 101 Crawfords Corner Road, Holmdel, NJ, 07733-3030, US

(21) Appl. No.: 11/481,625

(22) Filed: Jul. 6, 2006

(51) Int. Cl. H04Q 7/20

(52) U.S. Cl. 455/445; 455/433

(57) ABSTRACT

A method is provided of call setup between a calling terminal and a called mobile terminal. The calling terminal is in a first telecommunications network. The called mobile terminal has a home telecommunications network and roams in a second telecommunications network that is not its home network. The second network is for wireless telecommunications. The second network forwards information as to the location of the called terminal to the first network. The calling terminal receives information as to the location of the called terminal before call setup is completed.

### FIELD OF THE INVENTION

The present invention relates to telecommunications, in particular to wireless telecommunications.

### DESCRIPTION OF THE RELATED ART

In known systems, it is possible to make a call to a mobile terminal that is roaming outside of its home network, without the caller being aware that the mobile terminal is roaming. Accordingly the caller may not be aware that the called party is incurring costs associated with being outside of his home network when receiving a call. Also, the caller may not be aware that the called party may be at a geographic location having a different time zone to himself.

### SUMMARY OF THE INVENTION

The inventors found a way to inform the caller of the called mobile terminal's location before call set up is completed.

An example of the present invention is a method of call setup between a calling terminal and a called mobile terminal. The calling terminal is in a first telecommunications network. The called mobile terminal has a home telecommunications network and roams in a second telecommunications network that is not its home network. The second network is for wireless telecommunications. The second network forwards information as to the location of the called terminal to the first network. The calling terminal receives information as to the location of the called terminal before call setup is completed.

### BRIEF DESCRIPTION OF THE DRAWINGS

An embodiment of the present invention will now be described by way of example and with reference to the drawings, in which:

FIG. 1 is a diagram illustrating handling of a call originated from a mobile subscriber according to a first embodiment of the present invention.

FIG. 2 is a diagram illustrating handling of a call originated from within a Public Switched Telephone Network, PSTN, according to a second embodiment of the present invention.

### DETAILED DESCRIPTION

When considering a known system, the inventors realised that it would be useful to notify a caller placing a call that the called party is roaming. This would allow the caller to terminate the call, after being notified that the called party is roaming but before the call is connected, so as to avoid cost or inconvenience to the called party.

### Call Originated from a Mobile Subscriber

A system architecture is first described of a system in which a call is originated from a mobile terminal. The operation of the system is then described.

### System Architecture

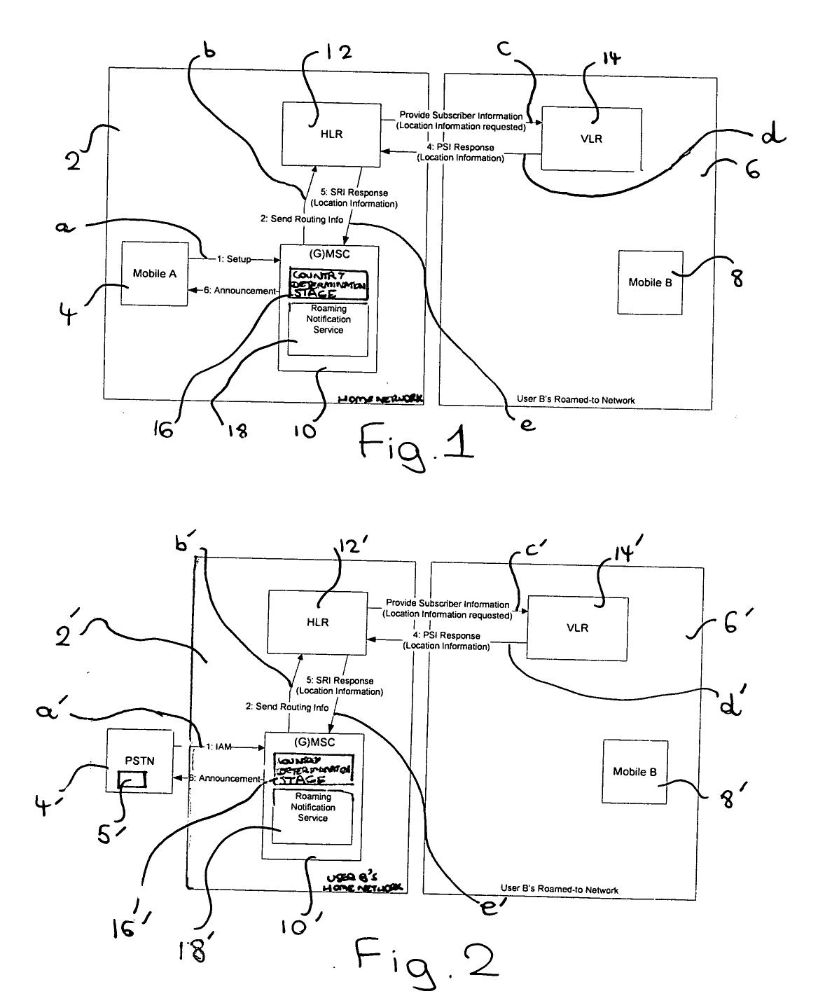

As shown in FIG. 1, there is a wireless telecommunications network 2 in which a first mobile terminal 4 is located. There is also a second wireless telecommunications network 6 in which a second mobile terminal 8 is currently located, in other words into which the second wireless terminal has roamed. The first network is the home network for both the first mobile terminal 4 and the second mobile terminal 8.

The first telecommunications network 2 includes a Gateway Mobile services Switching Centre, GMSC, 10. The first network 2 also includes a Home Location Register, HLR, 12. The second network 6 includes a Visitor Location Register, VLR, 14.

The Gateway Mobile services Switching Centre, GMSC, 10 includes a country determination stage 16, the function of which is described below, and a roaming notification stage 18, also described below.

### Operation

As shown in FIG. 1, the first terminal 4 places a call to the second terminal 8 by a call connection request being sent (step a) to the GMSC 10 of the wireless telecommunications network 2 in which the first terminal 4 resides.

The GMSC 10 determines the current location of the called party by sending (step b) a Send Routing Info request to the Home Location Register, HLR, 12.

As the called party, namely the second mobile terminal 8, is roaming in another network 6, the HLR 12 contacts the Visitor Location Register, VLR, 14 in the roamed-to network 6 by sending a “Provide Subscriber information” message to the VLR 14 so as to request (step c) location information as to the called mobile terminal 8.

The VLR 14 responds by sending (step d) a response back to the HLR 12. The response includes the identity of the network 6 in which the called mobile terminal 8 is currently roaming.

The HLR forwards (step e) to the GMSC 10 the identity of the network 6 in which the called mobile terminal 8 is currently roaming within a “Send Routing information” response.

This information of the identity of the network 6 in which the called mobile terminal 8 is currently roaming is used by the geographic location determination stage 16 within the GMSC 10 to determine the country in which the called mobile terminal 8 is currently roaming.

Assuming the called mobile terminal 8 is roaming, the GMSC 10 invokes operation of its a roaming notification stage 18. Accordingly, an announcement message is sent (step f), for example by voice or text, to notify the calling mobile terminal 4, and hence its user, of the current country of location of the called mobile terminal 8. The message includes invitations to select one or more of: terminating the call, sending a text message to the called mobile terminal 8, recording a message on the voicemail function of the called mobile terminal 8.

The above steps are all undertaken during call setup phase, that is before the call to the called mobile terminal 8 is connected. As the caller when placing a call is notified that the called mobile terminal 8′ is roaming prior to the called party being connected to the call, the caller can make an informed choice whether to terminate the call, send a text message or access the called mobile terminal's voicemail so as to leave a message. In consequence, the called party gains from lower costs and less inconvenience due to its roaming. For example, duration-based costs in receiving calls are reduced or avoided. Also, there is less chance of being called at unsuitable times, such as being woken in the middle of the night, due to time differences around the world.

The user of the calling mobile terminal 4 can select to enable or disable the roaming notification function, as he wishes. Likewise the user of the called mobile terminal 8 can select to enable or disable the roaming notification function, for example disabling the function so as to keep his location private from the calling user.

### Call Originated from within a Public Switched Telephone Network, PSTN

Having described above a system with a call from a mobile terminal, we now turn to describing a system in which a call is originated from within a PSTN. First the system architecture is described, then its operation.

### System Architecture

As shown in FIG. 2, there is a Public Switched Telephone Network, PSTN, telecommunications network 4′ in which a first terminal 5′ is located. There is a first wireless telecommunications network 2′ connected to the PSTN 4′. The first wireless telecommunications network 2′ is the home network of a mobile terminal 8′. There is also a wireless telecommunications network 6 in which the mobile terminal 8′ is currently located, in other words into which the mobile terminal 8′ has roamed.

The first telecommunications network 2′ includes a Gateway Mobile services Switching Centre, GMSC, 10′. The first network 2′ also includes a Home Location Register, HLR, 12. The second network 6′ includes a Visitor Location Register, VLR, 14′.

The Gateway Mobile services Switching Centre, GMSC, 10′ includes a country determination stage 16′, the function of which is described below, and a roaming notification stage 18′, also described below.

### Operation

As shown in FIG. 2, the first terminal 4′places a call to the second terminal 8′ by an Initial Address Message, IAM, being sent (step a′) to the GMSC 10′ of the wireless telecommunications network 2 in which the first terminal 4′ resides. Incidentally, the IAM is sent as part of a known call setup protocol known as ISUP (ISDN User Part, where ISDN stands for Integrated Services Digital Network) that is in accordance with known Signalling Services 7 standards.

The GMSC 10′ determines the current location of the called party by sending (step b′) a Send Routing Info request to the Home Location Register, HLR, 12′.

As the called party, namely the mobile terminal 8 is roaming in another network 6, the HLR 12′ contacts the Visitor Location Register, VLR, 14′ in the roamed-to network 6′ by sending a “Provide Subscriber information” message to the VLR 14′ so as to request (step c′) location information as to the called mobile terminal 8′.

The VLR 14′ responds by sending (step d′) a response back to the HLR 12′. The response includes the identity of the network 6′ in which the called mobile terminal 8′ is currently roaming.

The HLR forwards (step e′) to the GMSC 10′ the identity of the network 6′ in which the called mobile terminal 8′ is currently roaming within a “Send Routing information” response.

This information of the identity of the network 6′ in which the called mobile terminal 8′ is currently roaming is used by the geographic location determination stage 16′ within the GMSC 10′ to determine the country in which the called mobile terminal 8′ is currently roaming.

Assuming the called mobile terminal 8′ is roaming, the GMSC 10′ invokes operation of its a roaming notification stage 18′. Accordingly, an announcement message is sent (step f′) shown), for example by voice or text, to notify the calling terminal 4′, and hence its user, of the current country of location of the called mobile terminal 8′. The message includes invitations to select one or more of: terminating the call, sending a text message to the called mobile terminal 8′, recording a message on the voicemail function of the called mobile terminal 8′.

The above steps are all undertaken during call setup phase, that is, before the call to the called mobile terminal 8′ is connected. As the caller when placing a call is notified that the called mobile terminal 8′ is roaming prior to the called party being connected to the call, the caller can make an informed choice whether to terminate the call, send a text message or access the called mobile terminal's voicemail so as to leave a message. In consequence, the called party gains from lower costs and less inconvenience due to its roaming. For example, duration-based costs in receiving calls are reduced or avoided as potential callers are less likely to call. Also, there is less chance of being called at unsuitable times, such as being woken in the middle of the night, due to time differences around the world.

The user of the calling terminal 4 can select to enable or disable the roaming notification function. Likewise the user of the called mobile terminal 8′ can select to enable or disable the roaming notification function.

### Call Originated from within a Public Land Mobile Network

This is similar to the system described with reference to FIG. 2 above, save that the Public Switched Telephone Network, PSTN. is replaced by a Public Land Mobile Network, PLMN.

### General

In some embodiments, the information of the identity of the network in which the called mobile terminal is currently roaming is used by the geographic location determination stage within the Gateway Mobile services Switching Centre, GMSC, to determine the location within a country, for example the region, county, or city, in which the called mobile terminal is currently roaming. This may be translated into corresponding information as to time zone, which is also considered a type of geographic information.

In some embodiments, the information of the identity of the network in which the called mobile terminal is currently roaming is used by the geographic location determination stage within the GMSC to determine the local time zone of the area within which the called mobile terminal is currently roaming.

In some embodiments, the response from the Visitor Location Register, VLR, to the Home Location Register, HLR, includes geographic information of the called mobile terminal, in addition to the identity of the network in which the called mobile terminal is currently roaming.

In some embodiments, assuming the called mobile terminal is roaming, the GMSC invokes operation of its a roaming notification stage to send a message to notify the calling mobile terminal of the local time zone of the called mobile terminal. This is instead of, or in addition to, information of the current country of location of the called mobile terminal.

In some embodiments, for example where the calling terminal is a mobile terminal, the calling terminal and the called mobile terminal need not have the same home network.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of call setup between a calling terminal and a called mobile terminal, wherein:
the calling terminal is in a first telecommunications network,
the called mobile terminal has a home telecommunications network and roams in a second telecommunications network that is not its home network, the second network being for wireless telecommunications,
the second network forwards information as to the location of the called terminal to the first network,
the calling terminal receives information as to the location of the called terminal before call setup is completed.

2. A method according to claim 1, further comprising:
the calling terminal presenting the information to a user of the calling terminal.

3. A method according to claim 2, in which the calling terminal presents the information to a user of the calling terminal before the call set up is completed.

4. A method according to claim 1, further comprising:
the first network sending a request for location information of the called terminal in respond to a request from the calling terminal to set up the call.

5. A method according to claim 1, further comprising:
using the information to determine the geographic country or region into which the called mobile terminal is currently roaming, and
forwarding an announcement message regarding the country or region to the calling terminal.

6. A method according to claim 5, in which the home network includes a home location register and a processor, and the second network includes a visitor location register,
the visitor location register being queried to provide the information as to location of the called mobile terminal, the processor using the information to determine the geographic country or region into which the called mobile terminal is currently roaming and forwarding an announcement message regarding the country or region to the calling terminal.

7. A method according to claim 5, in which the announcement message comprises an invitation to terminate the call.

8. A method according to claim 5, in which the announcement message comprises an invitation to send a text message instead.

9. A method according to claim 5, in which the announcement message comprises an invitation to record a voicemail message.

10. A wireless telecommunications network, wherein
the network comprises a first processor and a second processor,
the first processor is operative to send a request for information as to location of a second terminal in response to a request from a first terminal requesting set up a call to a second terminal,
the second processor is operative to receive the information, determine geographic information from the received the information, and send a message towards the first terminal including the geographic information.

11. A wireless telecommunications network according to claim 10, in which the second processor is operative to send the message to the first terminal before call set up is completed.

12. A wireless telecommunications network according to claim 10 wherein the first processor is a home location register and the second processor is a switching centre.

13. A wireless telecommunications network according to claim 12, in which the switching centre is a Gateway Mobile services Switching Centre, GMSC.
